(19) United States
(12) Patent Application Publication
(10) Pub. No.: US 2026/0326936 A1
(43) Pub. Date: Oct. 22, 2026

(54) Unmanned Aerial Vehicle

(71) Applicant: Vantage Robotics, Inc., San Leandro, CA (US)

(72) Inventors: Johannes VAN NIEKERK, Livermore, CA (US); Tobin FISHER, San Francisco, CA (US)

(21) Appl. No.: 19/255,950

(22) Filed: Jun. 30, 2025

Related U.S. Application Data
(60) Provisional application No. 63/666,048, filed on Jun. 28, 2024.

(51) Int. Cl. B64U 20/83; B64U 10/14; B64U 20/50; B64U 20/70; B64U 20/87; B64U 30/29; B64U 50/23; B64U 50/30

(52) U.S. Cl. CPC B64U 20/83; B64U 10/14; B64U 20/50; B64U 20/70; B64U 20/87; B64U 30/29; B64U 50/23; B64U 50/30

(57) ABSTRACT

An unmanned aerial vehicle includes: a backbone; bulkheads; booms; motors; and a battery assembly. The backbone includes a printed circuit board including: a center section; a first lateral section; a second lateral section; a first flex section coupling the center section to the first lateral section; and a second flex section coupling the center section to the second lateral section opposite the first lateral section. The backbone is foldable along the first flex section and the second flex section. The bulkheads: are coupled to the first lateral section and the second lateral section of the backbone; and rigidly retain the center section, the first lateral section, and the second lateral section of the backbone in a convex geometry. The booms are coupled to the bulkheads. The motors are arranged on distal ends of the booms. The battery assembly is configured to transiently couple to the backbone.

### CROSS-REFERENCE TO RELATED APPLICATIONS

This application claims the benefit of U.S. Provisional Application No. 63/666,048, filed Jun. 28, 2024, which is hereby incorporated in its entirety by this reference.

### TECHNICAL FIELD

This invention relates generally to the field of unmanned aerial vehicles and, more specifically, to a new and useful lightweight, miniature unmanned aerial vehicle in the field of unmanned aerial vehicles.

### BRIEF DESCRIPTION OF THE FIGURES

FIG. 1 is a schematic representation of an unmanned aerial vehicle;

FIG. 2 is a schematic representation of the unmanned aerial vehicle;

FIGS. 3A and 3B are schematic representations of the unmanned aerial vehicle;

FIG. 4 is a schematic representation of the unmanned aerial vehicle;

FIG. 5 is a schematic representation of the unmanned aerial vehicle;

FIGS. 6A, 6B and 6B are schematic representations of the unmanned aerial vehicle;

FIGS. 7A and 7B are schematic representations of the unmanned aerial vehicle;

FIG. 8 is a schematic representation of the unmanned aerial vehicle;

FIGS. 9A and 9B are schematic representations of the unmanned aerial vehicle;

FIGS. 10A and 10B are schematic representations of the unmanned aerial vehicle;

FIG. 11 is a schematic representation of the unmanned aerial vehicle; and

FIG. 12 is a schematic representation of the unmanned aerial vehicle.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Unmanned Aerial Vehicle

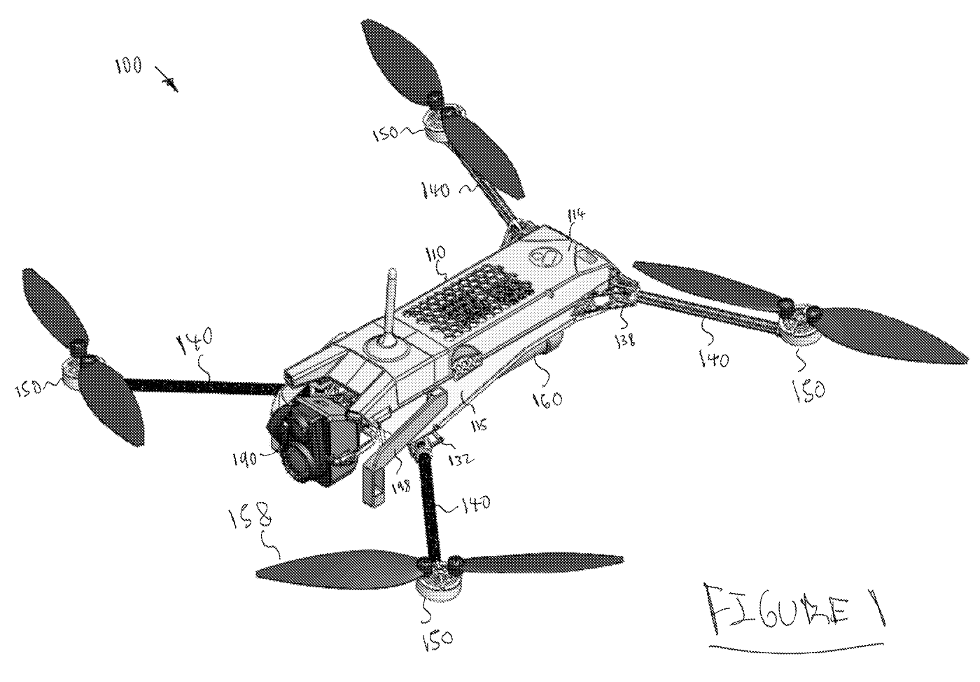

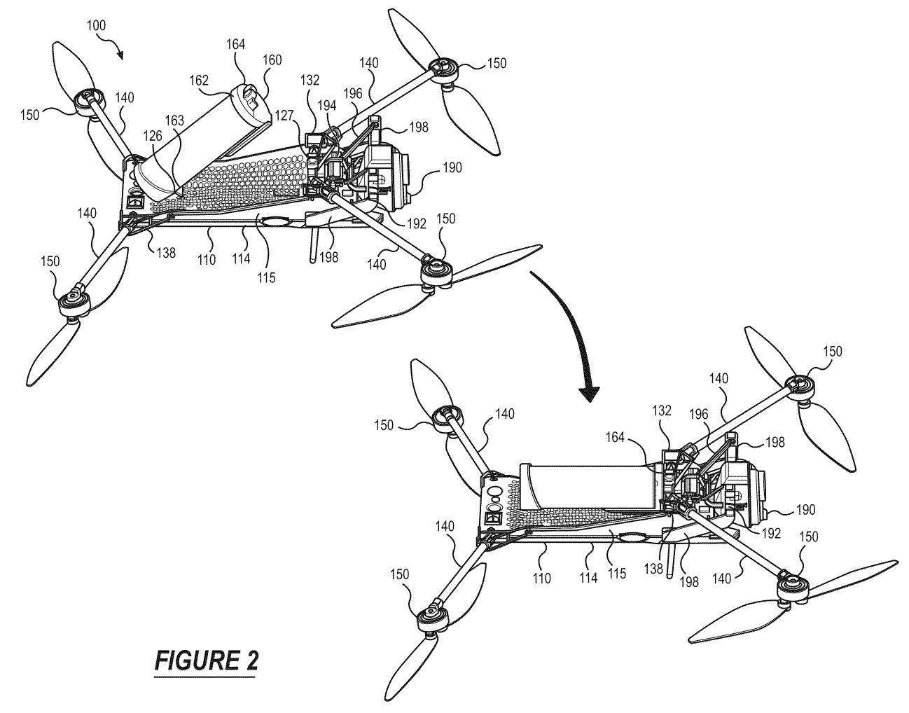

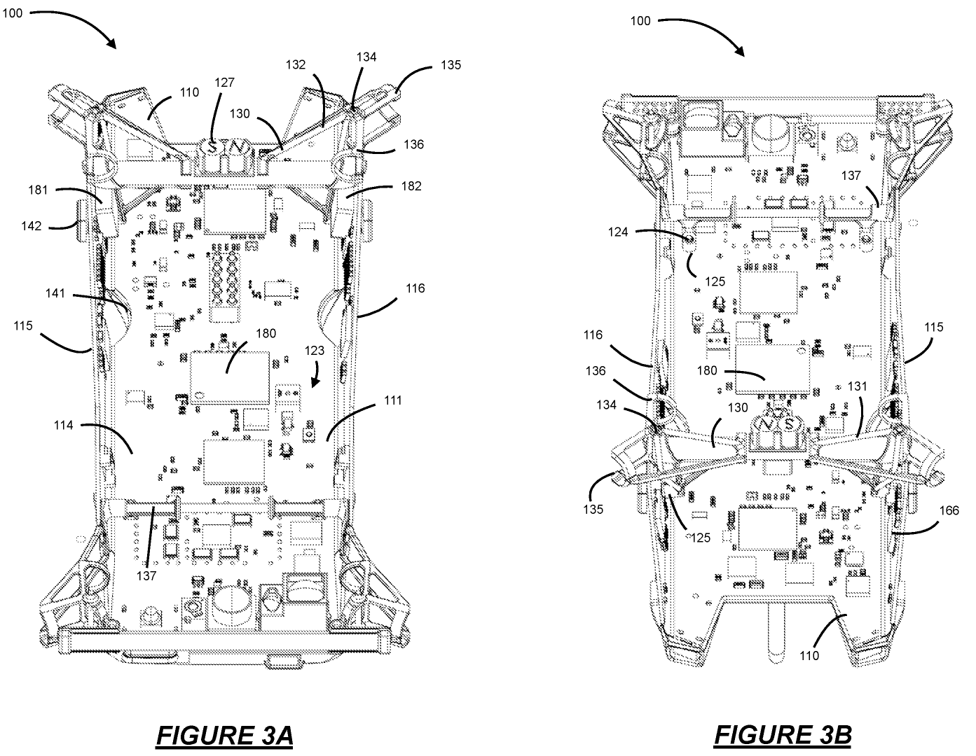

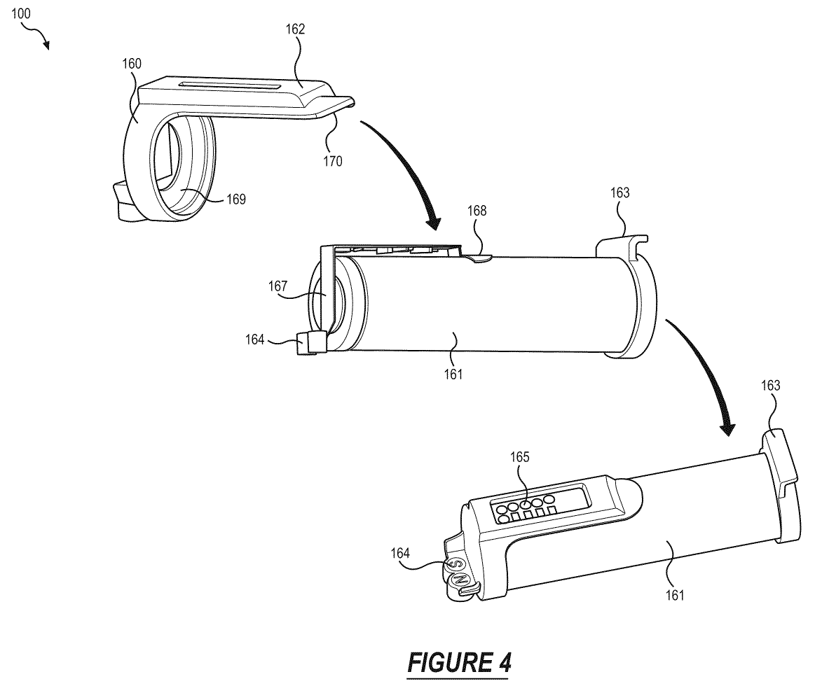

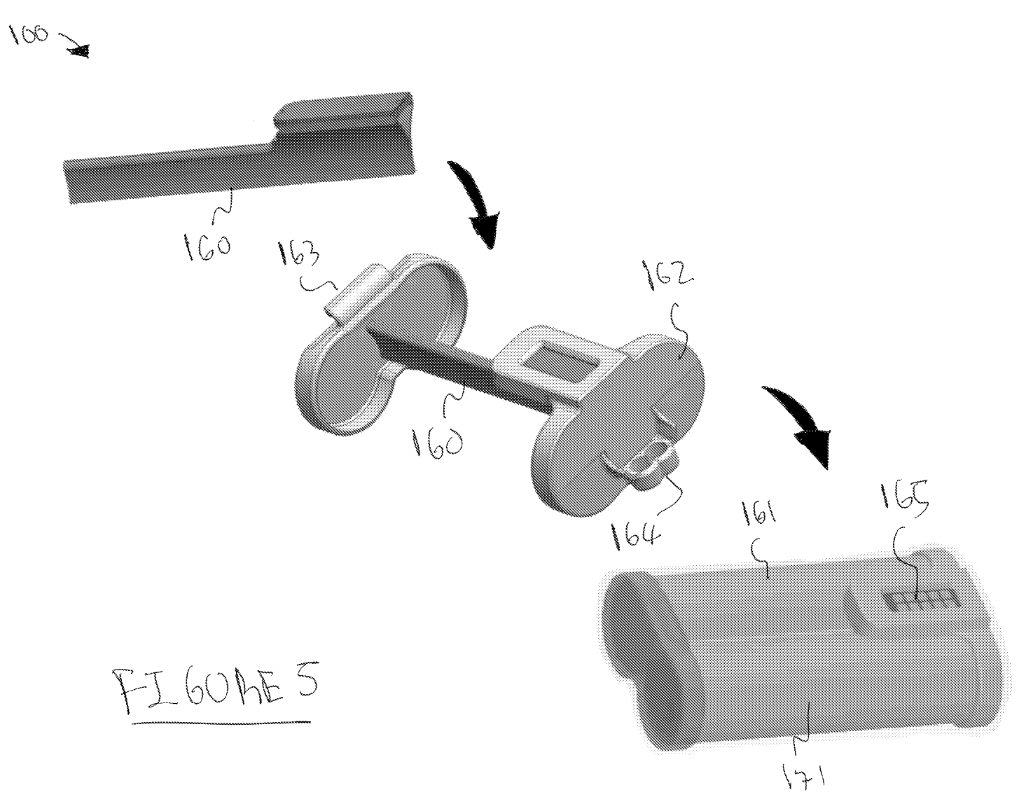

As shown in FIGS. 1, 2, 3A and 3B, an unmanned aerial vehicle 100 includes: a backbone 110; a set of bulkheads 130; a set of booms 140; a set of motors 150; and a battery assembly 160.

The backbone 110 includes a printed circuit board 111 including: a center section 114; a primary lateral section 115; a secondary lateral section 116; a primary flex section 117 coupling the center section 114 to the primary lateral section 115; and a secondary flex section 118 coupling the center section 114 to the secondary lateral section 116 opposite the primary lateral section 115. Additionally, the backbone 110 is foldable along the primary flex section 117 and the secondary flex section 118.

The set of bulkheads 130: are coupled to the primary lateral section 115 and the secondary lateral section 116 of the backbone 110; and rigidly retain the center section 114, the primary lateral section 115, and the secondary lateral section 116 of the backbone 110 in a convex geometry.

The set of booms 140: are coupled to the set of bulkheads 130; and extend outwardly from the backbone 110.

Each motor in the set of motors 150: is arranged on a distal end of a boom in the set of booms 140; and is configured to rotate a rotor to generate lift.

The battery assembly 160 is configured to transiently couple to the backbone 110.

### 1.1 Variation: Airframe

In one variation, as shown in FIGS. 1, 2, 3A and 3B, an unmanned aerial vehicle 100 includes: a chassis (or “airframe”); a set of booms 140; a set of motors 150; and a battery assembly 160.

The chassis includes a backbone 110 and a set of bulkheads 130. The backbone 110 includes a printed circuit board 111 that includes: a center section 114; a primary lateral section 115; a secondary lateral section 116; a primary flex section 117 coupling the center section 114 to the primary lateral section 115; and a secondary flex section 118 coupling the center section 114 to the secondary lateral section 116 opposite the primary lateral section 115. The backbone 110 is foldable along the primary flex section 117 and the secondary flex section 118. The set of bulkheads 130: are coupled to the primary lateral section 115 and the secondary lateral section 116 of the backbone 110; and rigidly retain the center section 114, the primary lateral section 115, and the secondary lateral section 116 of the backbone 110 in a convex geometry.

The set of booms 140 are pivotably coupled to the chassis.

Each motor in the set of motors 150: is arranged on a distal end of a boom in the set of booms 140; and is configured to rotate a rotor shell 155 to generate lift.

The battery assembly 160 is configured to transiently couple to the backbone 110.

### 1.2 Variation: Flat Pack Configuration

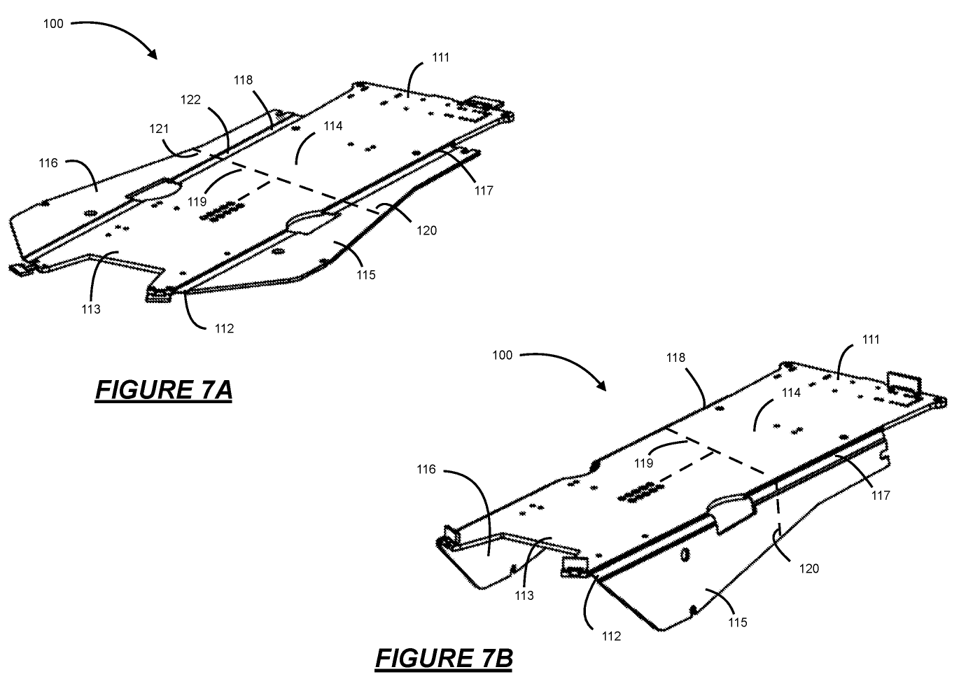

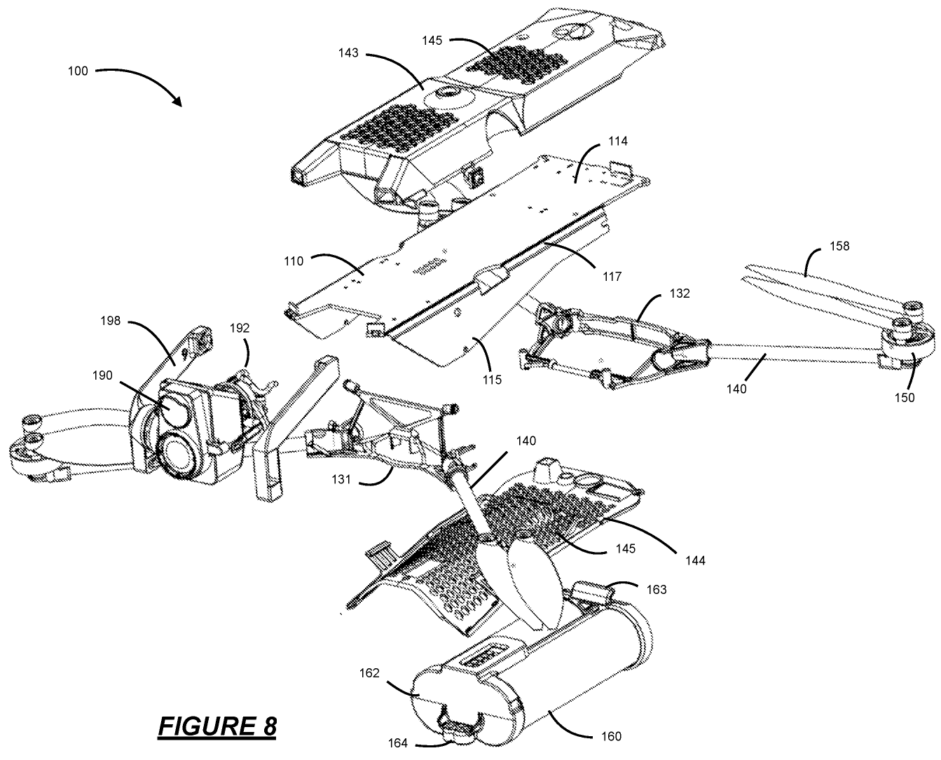

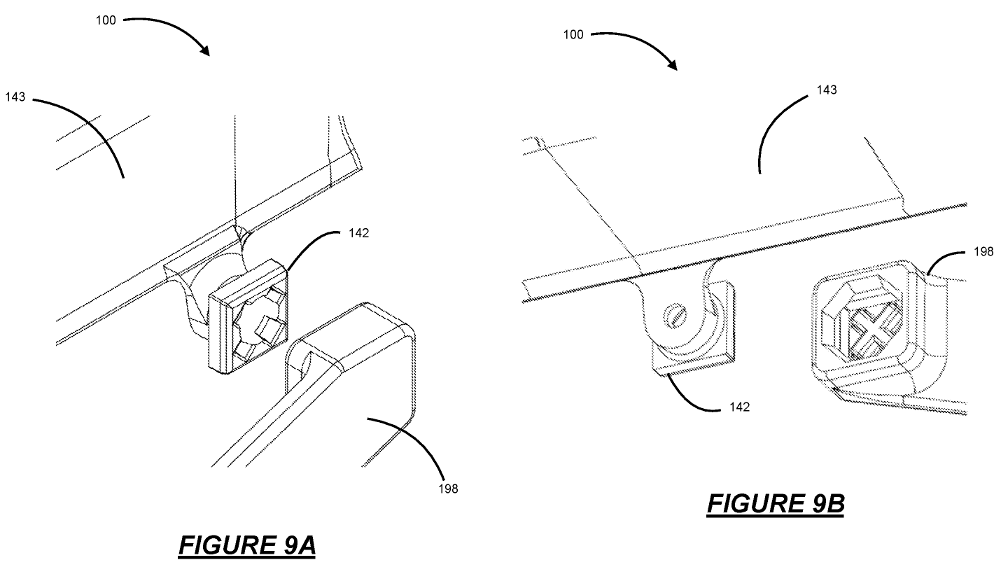

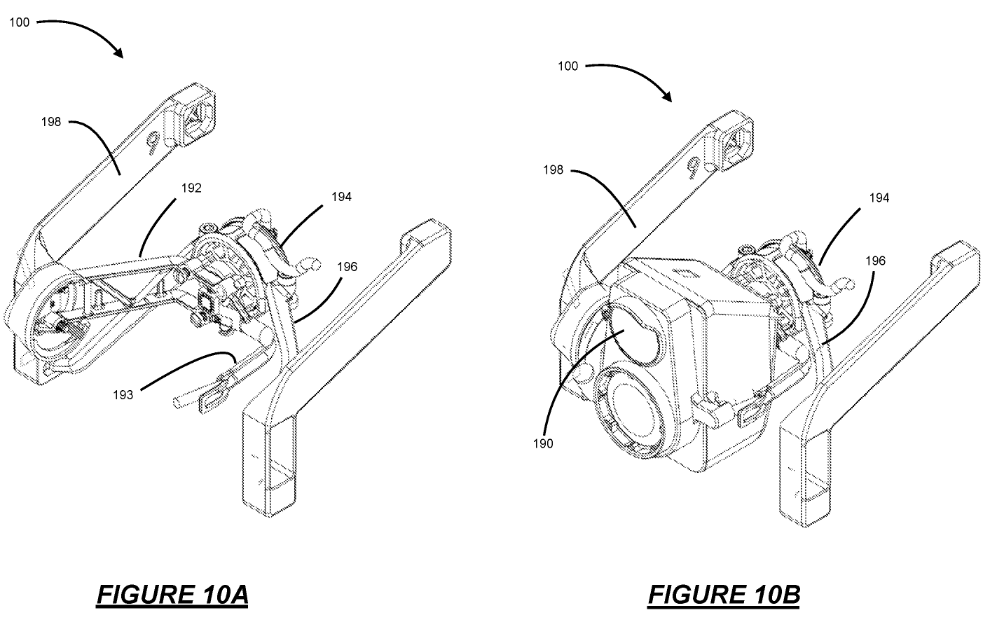

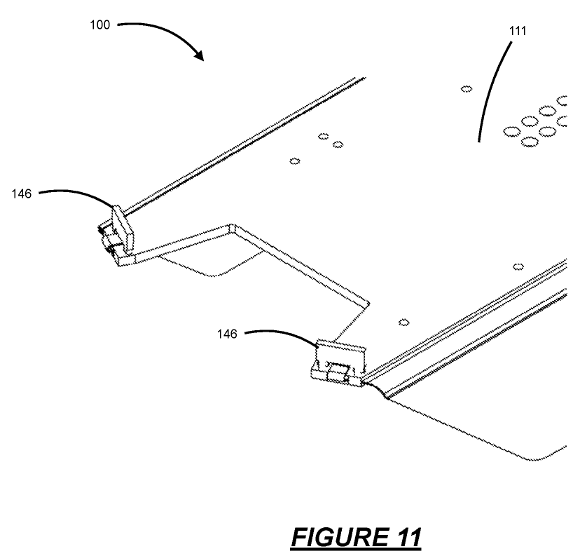

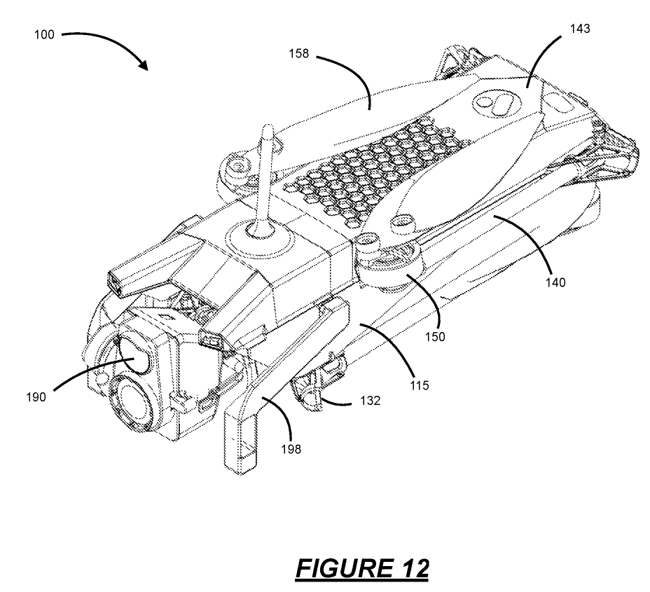

In another variation, as shown in FIGS. 1, 3A, 3B, 7A, 7B, and 7C, an unmanned aerial vehicle 100 includes: a backbone 110; a primary bulkhead 131; a set of booms 140; a set of motors 150; and a battery assembly 160.

The backbone 110 includes a printed circuit board 111 that includes: a center section 114; a primary lateral section 115; a secondary lateral section 116; a primary flex section 117 coupling the center section 114 to the primary lateral section 115; and a secondary flex section 118 coupling the center section 114 to the secondary lateral section 116 opposite the primary lateral section 115. The backbone 110 is foldable along the primary flex section 117 and the secondary flex section 118.

The primary bulkhead 131: is coupled to the primary lateral section 115 and the secondary lateral section 116 of the backbone 110; and rigidly retains the center section 114, the primary lateral section 115, and the secondary lateral section 116 of the backbone 110 in a convex geometry.

The set of booms 140 are pivotably coupled to the primary bulkhead 131.

Each motor in the set of motors 150 is arranged on a distal end of a boom in the set of booms 140.

The battery assembly 160 is configured to transiently couple to the backbone 110.

In this variation, the unmanned aerial vehicle 100 is operable in a flat pack configuration to: separate the primary bulkhead 131 from the backbone 110; and locate the primary lateral section 115 and the secondary lateral section 116 coplanar with the center section 114 of the backbone 110.

Additionally, the unmanned aerial vehicle 100 is operable in a deployed configuration to: locate the primary lateral section 115 and the secondary lateral section 116 orthogonal to the center section 114 of the backbone 110; and couple the primary bulkhead 131 to the backbone 110 by passing a set of fasteners 124 through a set of bores 125 of the backbone 110 and into the primary bulkhead 131.

### 2. Applications

Generally, an unmanned aerial vehicle 100 can function as a lightweight miniature quadcopter, such as weighing less than 300 grams and including fewer than 30 discrete parts or assemblies, but exhibiting comprehensive flight and low-noise image capture characteristics.

In particular, the unmanned aerial vehicle 100 includes: a backbone 110, including a printed circuit board 111, that functions as a central support element enabling mechanical integration of structural elements (e.g., frame, gimbal assembly 192) and electrical integration of electronic components (e.g., flight controller 180, flight sensors, motor controllers) to the unmanned aerial vehicle 100; and a set of bulkheads 130 (e.g., a front bulkhead and a rear bulkhead), which couple to the backbone 110 to form a rigid airframe structure, thereby increasing dimensional stability and torsional rigidity during flight operation of the unmanned aerial vehicle 100.

In one implementation, the printed circuit board 111 includes: a center section 114; a primary lateral section 115; a secondary lateral section 116; a primary flex section 117 coupling the center section 114 to the primary lateral section 115; and a secondary flex section 118 coupling the center section 114 to the secondary lateral section 116 opposite the primary lateral section 115. Additionally, the printed circuit board 111 includes: a flexible circuit board layer 112 (e.g., polyimide); and a rigid circuit board layer 113 bonded to the flexible circuit board layer 112. The rigid circuit board layer 113: is relieved over the primary flex section 117 between the center section 114 and the primary lateral section 115; and is relieved over the secondary flex section 118 between the center section 114 and the secondary lateral section 116. Accordingly, the primary flex section 117 defines a primary compliant region (or “living hinge”) of the backbone 110 that allows rotation of the primary lateral section 115 about a primary fold axis parallel to a primary lateral side of the center section 114. Additionally, the secondary flex section 118 defines a secondary compliant region that allows rotation of the secondary lateral section 116 about a secondary fold axis parallel to a secondary lateral side of the center section 114. Furthermore, the printed circuit board 111 can include electrical traces across the flexible circuit board layer 112 and the rigid circuit board layer 113 that electrically interconnect components across the center section 114, the primary lateral section 115, and the secondary lateral section 116 of the backbone 110.

For example, the center section 114 of the backbone 110 can include: a flight controller 180; a battery connection port; a radio receiver configured to receive communication signals from a remote-control transmitter (e.g., handheld-controller, remote computer system); a data communication port; a global positioning sensor; time-of-flight sensor 146; optical flow sensor; visual inertial odometry sensor, etc. The primary lateral section 115 includes a primary set of motor controllers electrically coupled to the flight controller 180 via the electrical traces on the printed circuit board 111. Similarly, the secondary lateral section 116 includes a secondary set of motor controllers electrically coupled to the flight controller 180 via the electrical traces on the printed circuit board 111.

Each bulkhead, in the set of bulkheads 130, independently couple to the backbone 110 to structurally maintain the printed circuit board 111 in the convex geometry. For example, a primary bulkhead 131 (e.g., a front bulkhead) and a secondary bulkhead 137 (e.g., a rear bulkhead) can be manufactured in a lightweight metal (e.g., titanium, aluminum, magnesium), such as via selective laser melting, direct metal laser sintering, investment casting, computer numerical control machine tools, or other fabrication techniques. Additionally, the set of bulkheads 130 can be formed of a high strength polymer or composite material (e.g., carbon reinforced nylon, carbon-epoxy composite), which can be manufactured with injection molding, 3d printing, or composite fabrication techniques. The primary bulkhead 131 includes: a front crossbeam arranged at a front end of the center section 114 and interposed between the primary lateral section 115 and the secondary lateral section 116 of the backbone 110; and a primary set of mounting brackets rigidly coupling the front crossbeam to the secondary lateral section 116 and the primary lateral section 115 of the backbone 110. Similarly, the secondary bulkhead 137 includes: a rear crossbeam arranged at a rear end of the center section 114 and interposed between the primary lateral section 115 and the secondary lateral section 116 of the backbone 110; and a secondary set of mounting brackets rigidly coupling the rear crossbeam to the secondary lateral section 116 and the primary lateral section 115 of the backbone 110.

Accordingly, the primary bulkhead 131 and the secondary bulkhead 137 function to: rigidly maintain the backbone 110 in the convex geometry; and increase torsional rigidity of the backbone 110 during a flight operation. Additionally, the primary bulkhead 131 and the secondary bulkhead 137 are coupled to (e.g., pivotably coupled) a set of booms 140 supporting a set of motors 150, which are configured to rotate a set of rotors to induce lift of the unmanned aerial vehicle 100.

Therefore, rather than implementing a separate rigid structure (e.g., chassis) to support a printed circuit board assembly, the unmanned aerial vehicle 100 can include a foldable, flexible, lightweight (e.g., 20 grams) printed circuit board 111 that functions both as: a central support element (or “backbone 110”) of the unmanned aerial vehicle 100; and a power and data bus for electrical communications between a battery, a flight controller 180, sensors, motor drivers, motors, and other actuators. Accordingly, the unmanned aerial vehicle 100 exhibits lower weight and less unmanned aerial vehicle 100 complexity (i.e., a lower count of unique components) while maintaining structural and electrical integrity. During flight operation, the backbone 110 remains exposed to wakes and wash from the rotors, which force air across electrical components (e.g., flight controller 180, motor controllers, battery) on the backbone 110, thereby passively cooling these components without implementation of additional active cooling components thermal management. For example, higher unmanned aerial vehicle 100 airspeeds may not only yield greater resistive heating across the backbone 110 but also greater wake and wash velocity from the rotors and thus greater cooling rates of air moving around the exposed backbone 110.

### 2.1 Gimbal Assembly and Imaging

The unmanned aerial vehicle 100 also includes a gimbal assembly 192, including a set of isolating arms 198 (e.g., elastomeric gimbal mounts) configured to mount to the primary bulkhead 131, to cantilever a motorized gimbal 194 and optical sensor 190 from the primary bulkhead 131, and to isolate the motorized gimbal 194 and optical sensor 190 from vibrations transmitted into the airframe by rotations of the motors. More specifically, the unmanned aerial vehicle 100 can include two isolating arms flexibly coupled to each side of a front crossbeam of the primary bulkhead 131 and extending parallel toward a front end of the unmanned aerial vehicle 100. Furthermore, the gimbal assembly 192 can include a connector configured to couple a port arranged on a bottom side of the backbone 110: to supply power to a set of gimbal motors (e.g., roll- and pan- stage motors); to route an image feed captured by an optical sensor 190 at the gimbal assembly 192 to an on-board controller at the backbone 110; and to route inertial measurement data to a gimbal controller.

For example, square-shouldered washers can be located under threaded fasteners passing through the secondary and primary lateral sections of the backbone 110 into the primary bulkhead 131. The proximal ends of the two isolating arms can include square bores configured to engage and retain these square-shouldered washers via interference fit.

The gimbal mounts can thus sway laterally and elastically deform in each others degree of freedom to damp oscillations travelling from the airframe into the gimbal assembly 192, thereby reducing vibration of the optical sensor 190 and noise in images captured by the optical sensor 190.

### 2.2 Crash Resistance

Furthermore, the unmanned aerial vehicle 100 can include: a battery assembly 160 retained at the backbone 110 by a mechanical hook 163 coupled to a rear crossbeam of the secondary bulkhead 137 cooperating with a set of magnetic elements 164 coupled to adjacent magnetic elements at a front crossbeam of the primary bulkhead 131; a set of rotors retained on a set of motors 150 via magnetic elements at distal ends of the set of booms 140; and a gimbal assembly 192 including gimbal mounts (e.g., elastomeric arms) to connect to a feature (e.g., square feature) at the backbone 110 via an interference fit. During a crash event, the unmanned aerial vehicle 100 may overcome coupling of the battery assembly 160 and the set of rotors. Thus, the battery assembly 160 and the rotors can eject from the airframe (i.e., primary bulkhead 131, secondary bulkhead 137, and backbone 110) to: move a high-mass element (i.e., the battery assembly 160) with greatest fire risk away from the airframe; and release high-kinetic energy elements (e.g., the rotors) from the booms and airframe rather than transferring this energy to the airframe (i.e., primary bulkhead 131, secondary bulkhead 137, and backbone 110). Similarly, impact from a crash event may overcome the interference fit of the set of isolating arms 198. Thus, the gimbal assembly 192 can eject from the airframe to move a secondary high-mass element (i.e., the gimbal assembly 192, optical sensor 190) with fire risk away from the airframe (i.e., the primary bulkhead 131, the secondary bulkhead 137, and the backbone 110).

Therefore, the unmanned aerial vehicle 100 can include a battery assembly 160, a set of rotors, and a gimbal assembly 192 configured to release from the airframe (i.e., primary bulkhead 131, secondary bulkhead 137, and backbone 110) – such as in the event of a crash – and carry energy (e.g., kinetic energy) away from the airframe, thus reducing impact damage into the airframe, and reducing likelihood of damage to the airframe. Furthermore, following the crash event, components that may have released from the airframe (e.g., rotors, battery assembly 160) can then be collected and reassembled to the airframe or selectively replaced to redeploy the unmanned aerial vehicle 100 for flight operation.

### 3. Backbone

In one implementation, the unmanned aerial vehicle 100 includes a backbone 110, including a printed circuit board 111, functioning as a central support element enabling mechanical integration of structural elements (e.g., frame, props, gimbal) and electrical integration of electronic elements (e.g., flight controller 180, power distribution board, motor controllers, battery, suite of sensors) to the unmanned aerial vehicle 100. In one example, the backbone 110 can be manufactured as a substantially planar printed circuit board assembly, defining compliant regions, that can then be folded such as via folding fixtures, manual tools, and bending machines to form a convex geometry (e.g., an inverted square-U-shaped geometry) for the backbone 110.

As described above, the printed circuit board 111 includes: a center section 114; a primary lateral section 115; a secondary lateral section 116; a primary flex section 117 coupling the center section 114 to the primary lateral section 115; and a secondary flex section 118 coupling the center section 114 to the secondary lateral section 116 opposite the primary lateral section 115. Additionally, the printed circuit board 111 includes: a flexible circuit board layer 112 (e.g., polyimide); and a rigid circuit board layer 113 bonded to the flexible circuit board layer 112. The rigid circuit board layer 113: is relieved over the primary flex section 117 between the center section 114 and the primary lateral section 115; and is relieved over the secondary flex section 118 between the center section 114 and the secondary lateral section 116.

Accordingly, the primary flex section 117 defines a primary compliant region (or “living hinge”) of the backbone 110 that allows rotation of the primary lateral section 115 about a primary fold axis parallel to a primary lateral side of the center section 114. Additionally, the secondary flex section 118 defines a secondary compliant region that allows rotation of the secondary lateral section 116 about a secondary fold axis parallel to a secondary lateral side of the center section 114.

### 3.1 Electrical Traces

In one implementation, the printed circuit board 111 includes a set of electrical traces, such as arranged across the rigid circuit board layer 113 and the flexible circuit board layer 112, that interconnects components (e.g., flight controller 180, motor controllers, flight sensors) arranged on the printed circuit board 111. Accordingly, the printed circuit board 111 can maintain electrical connection across these components during transition from a planar configuration to a convex geometry configuration.

In this implementation, the center section 114 of the backbone 110 is formed by the rigid circuit board layer 113 and includes a center set of electrical traces 119. Additionally, the primary lateral section 115 of the backbone 110 is formed by the rigid circuit board layer 113 and includes a primary set of electrical traces 120. Similarly, the secondary lateral section 116 of the backbone 110 is formed by the rigid circuit board layer 113 and includes a secondary set of electrical traces 121. Furthermore, the flexible circuit board layer 112 includes a tertiary set of electrical traces 122 that electrically couple the center set of electrical traces 119 to: the primary set of electrical traces 120 across the primary lateral section 115; and the secondary set of electrical traces 121 across the secondary lateral section 116.

In one example, the printed circuit board 111 includes: a flight controller 180 arranged on the center section 114 and electrically coupled to the center set of electrical traces 119; a primary motor controller 181 arranged on the primary lateral section 115, electrically coupled to the primary set of electrical traces 120, and electrically coupled to a primary motor in the set of motors 150; and a secondary motor controller 182 arranged on the secondary lateral section 116, electrically coupled to the secondary set of electrical traces 121, and electrically coupled to a secondary motor in the set of motors 150. Accordingly, the tertiary set of electrical traces 122 on the flexible circuit board layer 112 electrically couple: the primary motor controller 181 on the primary lateral section 115 to the flight controller 180 on the center section 114; and the secondary motor controller 182 on the secondary lateral section 116 to the flight controller 180 on the center section 114.

Therefore, the printed circuit board 111 can include electrical traces that: maintains electrical continuity between the flight controller 180 and the motor controllers during mechanical transition of the printed circuit board 111 from a planar configuration to a convex geometry; eliminates the need for discrete connectors, jumper wires, or external harnessing to interconnect components across rigid sections of the backbone 110; and reduces system assembly complexity by enabling automated manufacture and registration of electrical pathways within a single multilayer circuit board.

### 3.1.1 Time of Flight Sensors

In one implementation, the unmanned aerial vehicle 100 can include a time-of-flight sensor 146 coupled to the center section 114 of the backbone 110. In this implementation, the time-of-flight sensor 146 includes a set of pins that are inserted within through holes arranged on the center section 114. Accordingly, the set of pins can be soldered to the through holes to mechanically retain the time-of-flight sensor 146 to the center section 114. Furthermore, the center section 114 can include electrical traces configured to route electrical signals from the time-of-flight sensor 146 to other electrical components (e.g., the flight controller 180) arranged on the backbone 110. Thus, the set of pins of the time-of-flight sensor 146: mechanically retain the time-of-flight sensor 146 to the center section 114; and electrically couple the time-of-flight sensor 146 to the other electrical components on the backbone 110.

In another implementation, the time-of-flight sensor 146: is mechanically mounted to the center section 114 via the set of pins inserted into the through holes of the center section 114; and is electrically coupled to other electrical components on the backbone 110 via a flex segment extending from a periphery of the printed circuit board 111. In this implementation, the flexible circuit board layer 112, of the printed circuit board 111, includes a flex segment: including electrical traces; and extending from a periphery of the center section 114 and coupled to the time-of-flight sensor 146. Thus, the electrical traces on the flex segment electrically couple the time-of-flight sensor 146 to the flight controller 180 and other electrical components arranged on the printed circuit board 111.

Therefore, the unmanned aerial vehicle can: reduce component count and interconnect complexity by eliminating the need for dedicated connectors or cabling to interface with the time-of-flight sensor 146; leverage electrical traces embedded in the flexible circuit board layer 112 to route signals between the time-of-flight sensor 146 and other electrical components on the backbone 110; and leverage the rigid circuit board layer 113 to mechanically retain the time-of-flight sensor 146 to the backbone 110 without additional fasteners or brackets.

The unmanned aerial vehicle 100 can then repeat this mounting structure for a set of time-of-flight sensors 146 arranged on the backbone 110 (e.g., the center section 114, the primary lateral section 115, the secondary lateral section 116).

### 3.2 Passive Cooling

In one implementation, the unmanned aerial vehicle 100 includes components (e.g., the flight controller 180, the set of motor controllers) arranged on an interior face 123 of the backbone 110. Additionally, the printed circuit board 111 can include a set of apertures 141, such as arranged across flex regions interposed between the center section 114 and the respective lateral sections of the backbone 110, that route airflow across the interior face 123 of the backbone 110 to passively cool these components.

In another implementation, the printed circuit board 111 includes components (e.g., the flight controller 180, the motor controllers, antennas) arranged on both interior and exterior faces of the backbone 110. In this implementation, the printed circuit board 111 can include a coating (e.g., a conformal coating): arranged across and interior face and an exterior face of the printed circuit board 111; and configured to shield electrical components arranged on the backbone 110 from environmental exposure (e.g., moisture, liquids) without impairing thermal dissipation from these electrical components during a flight operation. Additionally, the unmanned aerial vehicle 100 can further include a set of covers (e.g., a top cover 143 and a bottom cover 144) that: encompass the backbone 110 to define an enclosed volume; are configured to protect the electrical components, such as from debris ingress, liquid exposure, mechanical impact and electrostatic shock damage; and include a set of perforations that route airflow across the interior and exterior faces of the backbone 110 during flight operation.

Therefore, the backbone 110 routes ambient airflow across heat-generating components during flight operation, thereby eliminating the need for dedicated cooling elements such as heatsinks, fans, or forced-air ducts.

### 3.3 Sensors + Modules

In one implementation, the backbone 110 can include: a flight controller 180; a set of motor controllers (e.g., electronic speed controllers) configured to electrically couple to a set of motors 150; a video processing unit configured to process image data received from the optical sensor; a battery connection port configured to receive a connector 165 of the battery assembly 160; a radio transceiver configured to receive and send communication signals to and from a remote-control transmitter (e.g., handheld-controller); a data communication port configured to couple an external device (e.g., computer system); a gimbal camera port configured to couple a gimbal assembly 192 and an optical sensor 190; a global positioning module; a set of flight sensors; and a power distribution board configured to route electrical power from the battery connection port to electrical components at the backbone 110. However, the backbone 110 can include additional modules and sensors (e.g., accelerometers, gyroscopes, barometers, magnetometers) to aid during flight operation of the unmanned aerial vehicle 100.

### 3.4 Touch Electrodes

In one implementation, as described above, the backbone 110 includes: a center section 114; a primary lateral section 115 including a primary touch electrode; and a secondary lateral section 116 including a secondary touch electrode. In this implementation, the primary touch electrode and the secondary touch electrode can function as a low-resolution touch sensor that exhibits changes in electrical value (e.g., capacitance) responsive to application of a touch input by an operator handling the unmanned aerial vehicle 100. Accordingly, the unmanned aerial vehicle 100 can: detect touch inputs (e.g., touch inputs from an operator) applied to the primary lateral section 115 and the secondary lateral section 116; and execute flight controls based on inputs detected at these secondary and primary lateral sections.

During handling of the unmanned aerial vehicle 100 by an operator, the unmanned aerial vehicle 100 can: read a set of electrical values from the primary touch electrode and the secondary touch electrode; detect application of a touch input by an operator to the primary lateral section 115 and/or the secondary lateral section 116 of the backbone 110 based on these electrical values such as based on deviation of the electrical values from baseline electrical values; and, in response to detecting application of the touch input, transition from a standby state to a pre-takeoff state and/or transition from a hover state to a standby state.

Alternatively, the unmanned aerial vehicle 100 can: read a set of electrical values from the primary touch electrode and the secondary touch electrode; detect absence of application of a touch input by an operator to the primary lateral section 115 and/or the secondary lateral section 116 of the backbone 110 based on these electrical values such as based on deviation of the electrical values from baseline electrical values; and, in response to detecting absence of the touch input, transition from the pre-takeoff state to a hover state and/or transition from a hover state to a landing state.

The unmanned aerial vehicle 100 can similarly detect objects proximal, but not in contact with, the unmanned aerial vehicle 100 based on changes in electrical values of the touch electrodes.

### 3.4.1 Operator Initiated Pre-Takeoff State.

In one implementation, the unmanned aerial vehicle 100 can: detect application of a touch input, via deviations in electrical values read from the primary touch electrode and the secondary touch electrode, indicative of handling by an operator; and interpret a spatial displacement of the unmanned aerial vehicle 100, detected via onboard sensors (e.g., inertial measurement units, accelerometers), as a gesture corresponding to the transition from the standby state to the pre-takeoff state. For example, the unmanned aerial vehicle 100 can: interpret a gesture corresponding to rotation of the unmanned aerial vehicle 100 about a vertical axis detected via onboard sensors; and/or interpret a gesture corresponding to application of a predetermined sequence of taps to the primary touch electrode and/or the secondary touch electrode.

The unmanned aerial vehicle 100 can transition from the standby state to the pre-takeoff state by: accessing initial sensor data from onboard sensors, such as inertial measurement units, gyroscopes, and accelerometers; calculating flight parameters, based on the initial sensor data, including initial motor throttle parameters and attitude setpoints configured to define a stable initial orientation prior to takeoff; and transmitting commands including the initial motor throttle parameters to the primary motor controller 181 and the secondary motor controller 182 to prepare the set of motors 150 for subsequent initiation of flight operations.

### 3.4.2 Operator Initiated Takeoff

In one implementation, the unmanned aerial vehicle 100 can: detect absence of a touch input by an operator based on electrical values from the primary touch electrode and/or the secondary touch electrode during the pre-takeoff state; and, in response to detecting the absence of the touch input, initiate a takeoff sequence. For example, the unmanned aerial vehicle 100 can: detect absence of the touch input from the user, such as in response to the operator throwing the unmanned aerial vehicle 100; and initiate the takeoff sequence.

During the takeoff sequence, the unmanned aerial vehicle 100 can: access sensor data from onboard sensors, such as inertial measurement units and gyroscopes; calculate motor throttle parameters based on the sensor data to maintain a target ascent rate and orientation; and transmit commands specifying the motor throttle parameters to the primary motor controller 181 and the secondary motor controller 182 to rotate corresponding propellers 158 in the set of motors 150 and execute ascent of the unmanned aerial vehicle 100. Accordingly, following the takeoff sequence, the unmanned aerial vehicle 100 can: transition to a hover state; maintain position and orientation based on sensor data from the onboard sensors; and await navigation commands transmitted from a user device (e.g., a handheld controller, a mobile device) specifying a target location or flight maneuver.

### 4. Bulkheads

In one implementation, the unmanned aerial vehicle 100 includes a set of bulkheads 130 that: fasten to the backbone 110 to rigidly retain the backbone 110 in a convex geometry (e.g., an inverted square-U geometry); and cooperate with the backbone 110 to form an airframe exhibiting high torsional strength. In particular, the set of bulkheads 130 can include a primary bulkhead 131 and a secondary bulkhead 137 that each independently couple (e.g., fasten) to the front and rear of the backbone 110 (i.e., rather than forming a unitary airframe structure that supports a PCB).

In one example, the primary bulkhead 131 and the secondary bulkhead 137 are fabricated via three-dimensional printing techniques (e.g., selective laser melting, direct metal laser sintering) to form lightweight, rigid metal (e.g., titanium) structures.

### 4.1 Rigidity: Front + Rear Bulkheads

In one implementation, the set of bulkheads 130 includes: a primary bulkhead 131 configured to couple a front end of the backbone 110; and a secondary bulkhead 137 configured to couple a rear end of the backbone 110 and cooperate with the primary bulkhead 131 to form a rigid airframe and increase dimensional stability of the backbone 110 in a substantially inverted square-U-shaped geometry and to increase torsional rigidity of the backbone 110 during flight operation of the unmanned aerial vehicle 100. In this implementation, the set of bulkheads 130 can be additively manufactured (e.g., 3D printed) from a titanium material.

The primary bulkhead 131 can include: a front crossbeam (e.g., carbon rod or tube) arranged proximal the front end of the center section 114 of the backbone 110 and interposed between the secondary lateral section 116 and the primary lateral section 115 of the backbone 110; and a front mounting bracket, such as a unitary structure formed via additive manufacturing, coupled to the front crossbeam. Additionally, the front mounting bracket: couples (e.g., via a fastener) the primary lateral section 115 of the backbone 110 to the secondary lateral section 116 of the backbone 110; and cooperates with the front crossbeam to maintain rigidity of the backbone 110 in the convex geometry. Accordingly, the primary bulkhead 131 rigidly couples to the front end of the backbone 110 to: constrain front ends of the secondary lateral section 116 and the primary lateral section 115 in a substantially orthogonal orientation to the center section 114 of the backbone 110; and increase torsional rigidity of the front end of the backbone 110 during flight operation of the unmanned aerial vehicle 100.

In one example, each of the primary lateral section 115 and the secondary lateral section 116 of the backbone 110 includes a set of bores 125 (e.g., through-bores) that align with through holes of the front mounting bracket. Thus, during assembly of the unmanned aerial vehicle 100, the mounting bracket is coupled to the front crossbeam align with the set of bores 125 (e.g., through-bores) on the inner faces of the secondary and primary lateral sections and thus can receive fasteners from the outer side of the secondary and primary lateral sections to rigidly couple the primary bulkhead 131 to the backbone 110.

Additionally, the secondary bulkhead 137 can include: a rear beam (e.g., carbon rod) arranged proximal the rear end of the center section 114 of the backbone 110 and interposed between the secondary lateral section 116 and the primary lateral section 115 of the backbone 110; a primary rear mounting bracket arranged proximal a primary end of the rear crossbeam and configured to couple (e.g., via a fastener) proximal the rear end of the center section 114 of the backbone 110; and a secondary rear mounting bracket arranged proximal a secondary end, opposite the primary end, of the rear crossbeam and configured to couple (e.g., via a fastener) proximal the rear end of the center section 114 of the backbone 110. Accordingly, the secondary bulkhead 137 rigidly couples to the rear end of the backbone 110 to: constrain rear ends of the secondary lateral section 116 and the primary lateral section 115 in a substantially orthogonal orientation to the center section 114 of the backbone 110; and increase torsional rigidity of the rear end of the backbone 110 during flight operation of the unmanned aerial vehicle 100.

Therefore, the unmanned aerial vehicle 100 can include: a primary bulkhead 131 coupled (e.g., via fasteners) to a front end of the backbone 110; and a secondary bulkhead 137 coupled (e.g., via fasteners) to a rear end of the backbone 110, that cooperates with the primary bulkhead 131 to increase torsional rigidity of the backbone 110 during flight operation of the unmanned aerial vehicle 100.

### 4.2 Flat Pack Configuration + Deployed Configuration

In one implementation, the unmanned aerial vehicle 100 is operable in a flat pack configuration and a deployed configuration. In the flat pack configuration, such as during manufacturing, assembly, and repair of the unmanned aerial vehicle 100: the set of bulkheads 130 are separated from the backbone 110; and the primary lateral section 115 and the secondary lateral section 116 of the backbone 110 are coplanar with the center section 114 of the backbone 110. A user can then implement folding fixtures, manual tools, and bending machines, to transition the unmanned aerial vehicle 100 from the flat pack configuration to the deployed configuration.

In the deployed configuration: the primary lateral section 115 is folded about the primary flex section 117 to locate the primary lateral section 115 orthogonal to the center section 114; the secondary lateral section 116 is folded about the secondary flex section 118 to locate the secondary lateral section 116 orthogonal to the center section 114 and facing the primary lateral section 115; and the set of bulkheads 130 are coupled to the backbone 110 by passing a set of fasteners 124 through a set of bores 125, arranged on the primary lateral section 115 and the secondary lateral section 116 of the backbone 110, and into the set of bulkheads 130. Therefore, a user can selectively transition the unmanned aerial vehicle 100 between the flat pack configuration and the deployed configuration via folding of the backbone 110, thereby simplifying inspection, repair, and assembly and providing unobstructed access to components and mechanical interfaces on the backbone 110.

### 4.3 Stowed + Flight Configurations

In one implementation, the unmanned aerial vehicle 100 includes a set of booms 140: pivotably (e.g., via pivot pins) coupled to the set of bulkheads 130; and operable in a stowed configuration during non-flight operation of the unmanned aerial vehicle 100 and a flight configuration during flight operation of the unmanned aerial vehicle 100. More specifically, in the stowed configuration, the set of booms 140 can be locked (e.g., via a locking mechanism) in a folded orientation substantially aligned with a longitudinal axis of the backbone 110. Furthermore, in the flight configuration, the set of booms 140 can be rotated outward and locked (e.g., via a locking mechanism) in a spread orientation (e.g., X-configuration) that positions corresponding propellers in unobstructed locations to support flight operation.

For example, each boom can include a proximal end defining a rod end configured to pivotably couple a boom mount 132 of the primary bulkhead 131 or secondary bulkhead 137. In this example, the boom mount 132 includes a boom retention interface (e.g., a tube) that is oversized for the proximal end of the boom. During assembly, a curing adhesive (e.g., epoxy, polyurethane) is applied to an internal cavity of the boom retention interface. Accordingly, the boom retention interface receives the proximal end of the boom to form a glue joint.

Additionally, the boom mount 132 can include: a pivot 134 including an axle passing through the boom retention interface at the proximal end of the boom; and a primary demilune (e.g., 200 degrees) cup defining an internal radius approximating an outer radius of the boom retention interface at the proximal end of the boom and extending along an axis parallel to a deployed boom direction, such as to locate the boom orthogonal to the center section 114 of the backbone 110. Accordingly, to deploy the boom, an operator can rotate the boom outwardly toward the primary demilune cup 135 such that the primary demilune cup 135: elastically deforms about the boom retention interface at the proximal end of the boom; seats the boom retention interface within the primary demilune cup 135; and returns to a nominal geometry to retain the boom retention interface at the primary demilune cup 135 and maintain the boom in a deployed boom configuration. Similarly, the boom mount 132 can include a secondary demilune cup 136 oriented along an axis of the boom in a retracted/stow direction, such as to locate the boom parallel to the center section 114 of the backbone 110. Thus, the unmanned aerial vehicle 100 can repeat this structure across a set of booms 140 coupled to the primary bulkhead 131 and secondary bulkhead 137 to enable an operator to selectively lock the set of booms 140 into a stowed configuration or a flight configuration. Alternatively, rather than including demilune cups, the unmanned aerial vehicle 100 can implement spring elements (e.g., a loop wire formations) arranged on a distal end of the boom mount that receive the boom retention interface at the proximal end of the boom to enable the operator to selectively lock the set of booms 140 into the stowed configuration or the flight configuration.

In the aforementioned example, three-dimensional printed techniques (e.g., selective laser melting, direct metal laser sintering) can be implemented to manufacture the boom mount 132 into a single/unitary lightweight structure (e.g., titanium structure), such as integrated into the front mounting bracket.

In one implementation, the unmanned aerial vehicle 100 includes: a front set of booms 140 pivotably coupled (e.g., via pivot pins) to the primary bulkhead 131 of the airframe; and a rear set of booms 140 pivotably coupled (e.g., via pivot pins) to the secondary bulkhead 137 of the airframe. In this implementation, each of the front set of booms 140 and the rear set of booms 140 can include a locking mechanism (e.g., C-shaped locking notch) configured to lock the front and rear set of booms 140 in the folded orientation substantially aligned with a longitudinal axis of the backbone 110 or in a spread orientation that positions corresponding propellers in unobstructed locations to support flight operation of the unmanned aerial vehicle 100. For example, the primary bulkhead 131 further includes: a boom mount 132 (e.g., titanium arm) pivotably coupled (e.g., via a pivot pin) to a primary end of the front crossbeam and configured to receive a boom retention interface arranged on the proximal end of the boom (e.g., hollow carbon rod); and a locking mechanism (e.g., C-shaped locking notch) configured to enable selective locking of the boom between the folded orientation and the spread orientation. In the spread orientation, the boom mount 132 – coupled to the boom retention interface at the proximal end of the boom – can be engaged to the locking mechanism via the boom retention interface, thus ensuring dimensional stability of the boom during flight operation of the unmanned aerial vehicle 100. In one example, the curing adhesive (e.g., epoxy, polyurethane) applied to the boom retention interface is characterized by a low-durometer (e.g., 20-40 Shore A) that functions to reduce mechanical vibrations (e.g., rotor induced vibrations) propagating through the boom toward the gimbal assembly 192. In this example, the unmanned aerial vehicle 100 can then repeat this structure across each boom, in the front set of booms 140 and the rear set of booms 140, coupled to the airframe.

Therefore, rather than implementing a set of booms 140 rigidly coupled to a chassis, the unmanned aerial vehicle 100 can include: a primary bulkhead 131 configured to pivotably couple a front set of booms 140; and a secondary bulkhead 137 configured to pivotably couple a rear set of booms 140. Accordingly, the unmanned aerial vehicle 100 can enable an operator to selectively set the booms in a stowed configuration in which the booms are substantially aligned with a longitudinal axis of the backbone 110 and a flight configuration in which the booms are locked into a substantially X-shaped configuration.

### 5. Booms + Motors + Rotors

In one implementation, the unmanned aerial vehicle 100 includes: a set of booms 140 coupled to the set of bulkheads 130; and a set of motors 150 arranged at distal ends of the set of booms 140 and configured to rotate rotors to induce lift. More specifically, the unmanned aerial vehicle 100 can include: a front set of booms 140 (e.g., hollow carbon fiber tubes) pivotably coupled to the primary bulkhead 131 of the airframe and including a primary set of leads extending through the front set of booms 140 coupling the set of motors 150 arranged on the front set of booms 140 to the motor controllers arranged on the secondary lateral section 116 and the primary lateral section 115 of the backbone 110; and a rear set of booms 140 (e.g., hollow carbon rods) pivotably coupled to the secondary bulkhead 137 of the airframe and including a secondary set of leads extending through the rear set of booms 140 coupling the set of motors 150 arranged on the rear set of booms 140 to the motor controllers arranged on the secondary lateral section 116 and primary lateral section 115 of the backbone 110.

Thus, during a flight operation, the flight controller 180 can then trigger the set of motors 150 to rotate propellers in order to induce lift of the unmanned aerial vehicle 100.

In one implementation, each boom includes a motor mount arranged at a distal end of the boom and configured to receive a motor. More specifically, the motor mount defines a cylindrical titanium structure (e.g., a structure weighing 0.2 grams) configured to receive and couple a stator base of a motor, without the implementation of fasteners and screw holes, configured to affix the motor and the rotor to the distal end of the boom. The unmanned aerial vehicle 100 can then repeat this structure across each boom coupled to the airframe (i.e., the primary bulkhead 131, the secondary bulkhead 137, and the backbone 111). In one example, three-dimensional printing techniques can be implemented to manufacture the motor mount as a unitary structure. Furthermore, each rotor is configured to magnetically couple a stator mount 151 at the distal end of the boom such that impact from a crash event can result in overcoming magnetic coupling between the rotor and the stator mount 151. Accordingly, the rotors can release from the airframe rather than transferring energy (e.g., kinetic energy) into the airframe in the event of a crash.

### 5.1 Motor Mount + Rotor

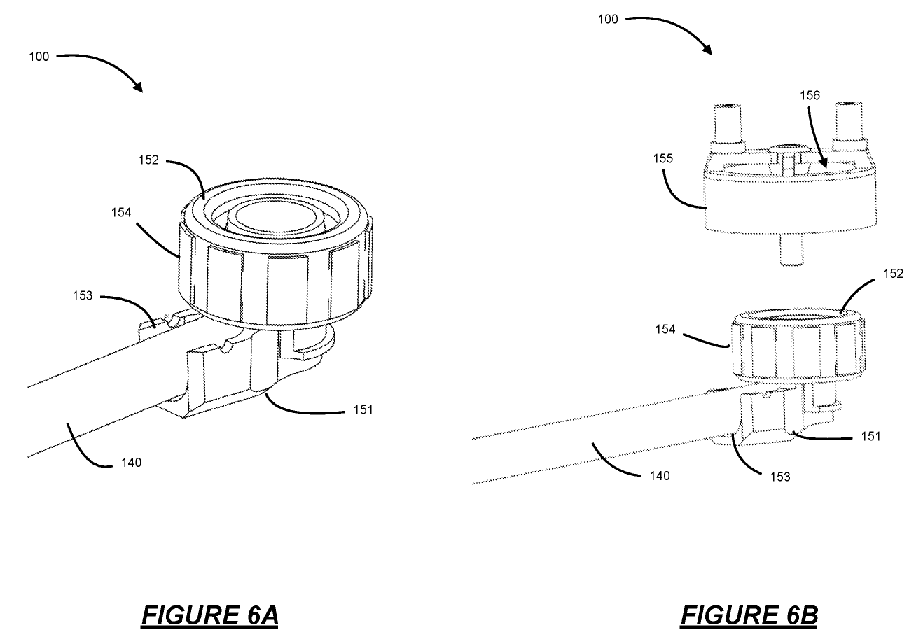

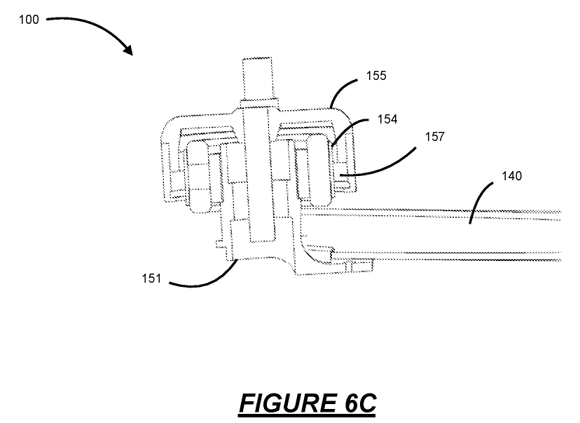

In one implementation, shown in FIGS. 6A, 6B and 6C, a motor, in the set of motors 150, includes: a stator mount 151; a radial array of stator windings 154; a rotor 155; and a propeller 158 coupled to the rotor 155. The stator mount 151 includes a column 152 (e.g., a cylindrical throat) and a boom cup 153 extending laterally from a base of the column 152 and configured to receive a distal end of a boom. Alternatively, the stator mount 151 can include a tube extending laterally from the base of the column 152 and configured to receive the distal end of the boom.

For example, the boom cup 153: defines an upward-facing aperture; is oversized for the distal end of the boom in the set of booms 140; and is adhesively bonded to the distal end of the boom. Additionally, the motor can include a radial array of stator windings 154 arranged about the column 152 above the boom cup 153. The rotor 155 includes: a cylindrical aperture 156 configured to receive the column 152; a shaft coaxial with a rotor axis of the rotor and configured to insert into a bore of a bearing at the stator mount 151; and a set of magnetic elements 157 arranged within the cylindrical aperture 156 and facing the radial array of stator windings 154. In one example, the propeller and the rotor 155 include a unitary structure to further reduce part count of the unmanned aerial vehicle 100.

Accordingly, during a flight operation, the radial array of stator windings 154 is configured to: retain the rotor 155 in a vertical position over the column 152 of the stator mount 151; and induce rotation of the rotor 155 and the propeller 158 to generate lift. In one example, the unmanned aerial vehicle 100 can: enable a user to remove or mount the rotors from corresponding motor mounts without requiring tools by disengaging magnetic coupling between the magnetic elements and the stator windings, thereby supporting rapid reconfiguration or replacement of rotors and propellers through repeatable, tool-free magnetic engagement.

Therefore, the unmanned aerial vehicle 100 can: eliminate mechanical retention components (e.g., circlips) by relying on magnetic coupling between magnetic elements and stator windings to retain each motor at respective booms; and enable the rotor 155 to disengage from the stator mount 151 in response to a collision event, thereby ejecting high-velocity rotating components away from the backbone 110 to reduce risk of impact damage to structural and electronic components of the unmanned aerial vehicle 100.

### 5.1.1 Glue Joint + Assembly

During assembly of the unmanned aerial vehicle 100 positional deviations between the motor mount 151 and the distal of the boom, and positional deviations between the boom retention interface and the proximal end of the boom can result in misalignment of motor placement. This misalignment can compromise flight stability and render the unmanned aerial vehicle 100 inoperable.

Accordingly, during assembly of the unmanned aerial vehicle 100, the stator mount 151 is coupled to a distal end of a boom, in the set of booms 140, via a curing adhesive (e.g., epoxy, polyurethane) to form a primary glue joint. Additionally, the boom retention interface is coupled to a proximal end of the boom via the curing adhesive to form a secondary glue joint. During assembly, the motor mount 151, the boom, and the boom retention interface are positioned within an alignment jig configured to define: a target orientation of the stator mount 151 relative to the distal end of the boom; and a target orientation of the boom retention interface relative to the proximal end of the boom. Thus, the primary glue joint cooperates with the alignment jig to accommodate dimensional tolerances between the stator mount 151 and the distal end of the boom, thereby maintaining the stator mount 151 in a target orientation relative to the distal end of the boom during curing of the adhesive of the primary glue joint. Additionally, the secondary glue joint cooperates with the alignment jig to accommodate dimensional tolerances between the boom retention interface and the proximal end of the boom, thereby maintaining the boom retention interface in a target orientation relative to the proximal end of the boom during curing of the adhesive of the secondary glue joint.

Thus, the primary glue joint and the secondary glue joint define tolerance-absorbing layers that cooperate with an alignment jig to support repeatable orientation of the motor mount 151 and the boom retention interface relative to the boom during the assembly process of the unmanned aerial vehicle 100. Therefore, instances of the unmanned aerial vehicle 100 can be repeatably manufactured while eliminating conventional intermediate mounting hardware.

### 5.1.2 Integrated Boom Mount + Motor

In one implementation, the stator mount 151 can be structurally integrated to the distal end of the boom. For example, the stator mount 151 and the boom can be additively manufactured as a unitary structure. Thus, the unmanned aerial vehicle 100 can: eliminate intermediate joints (e.g., glue joints), fasteners, and mounting components conventionally used to couple the stator mount to the boom; and reduce total vehicle mass and component count.

### 5.2 Thrust Plane Offset

In one implementation, the primary bulkhead 131 includes a primary set of boom mounts 132 (e.g., front boom mounts): arranged at a primary end of the backbone 110; arranged below the primary lateral section 115 and the secondary lateral section 116 of the backbone 110; and coupled to a primary set of booms (e.g., front booms) in the set of booms 140; and locating a primary set of motors (e.g., front motors), in the set of motors 150, supported by the primary set of booms within a primary thrust plane. In one example, the set of boom mounts are integrated (e.g., via additive manufacturing) into the mounting bracket of the primary bulkhead 131.

Additionally, the secondary bulkhead 137 includes a secondary set of boom mounts 138 (e.g., rear boom mounts): arranged at a secondary end, opposite the primary end, of the backbone 110; arranged above the primary set of boom mounts 132; coupled to a secondary set of booms (e.g., rear booms) in the set of booms 140; and locating a secondary set of motors (e.g., rear motors), in the set of motors 150, supported by the secondary set of booms within a secondary thrust plane vertically offset from the primary thrust plane.

Therefore, the set of bulkheads 130 cooperate to: vertically offset the primary thrust plane of the front motors from the secondary thrust plane of the rear motors; and provide clearance for an operator to grasp the unmanned aerial vehicle 100 without contacting the propellers.

### 6. Gimbal Assembly + Vibration Isolation

In one implementation, the unmanned aerial vehicle 100 can further include a gimbal assembly 192: transiently mountable to the backbone 110; coupled to an optical sensor 190 (e.g., a color camera, an infrared camera); and configured to isolate mechanical vibrations propagating through the backbone 110 from the optical sensor 190.

In this implementation, the gimbal assembly 192 can include: a set of gimbal motors 194 (e.g., a roll stage motor, a pitch stage motor); a gimbal frame 193 coupling the optical sensor 190 to the set of gimbal motors 194; a set of legs 196 extending from a roll stage motor (e.g., from a rotor side, from a stator side) in the set of gimbal motors 194; and a set of isolating arms 198 configured to couple the set of legs 196 to the backbone 110 and isolate mechanical vibrations propagating through the backbone 110 from the gimbal assembly 192 and the optical sensor 190. As described above, three-dimensional printing techniques or similar techniques (e.g., selective laser melting, direct metal laser sintering, investment casting, CNC) can be implemented to manufacture the gimbal frame 193.

In this implementation, the set of legs 196 define attachment points to the set of isolating arms 198 that are vertically aligned with a center of mass of the gimbal assembly 192 to minimize mechanical vibrations from inducing torque about a pitch axis of the gimbal assembly 192. The primary lateral section 115 and secondary lateral section 116 of the backbone 110 can include a set of retention features 142 (e.g., an H-shaped retention feature) configured to couple to bores of the set of isolating arms 198 via an interference fit to mechanically retain the gimbal assembly 192 relative to the backbone 110.

More specifically, each arm, in the set of isolating arms 198, includes: a primary stage (e.g., an angled stage) coupled to a primary retention feature in the set of retention features 142; and a secondary stage (e.g., a substantially vertical stage) extending from the primary stage and coupled to a secondary leg in the set of legs 196. For example, the primary stage (angled stage) of each isolation arm is configured to isolate axial and vertical mechanical vibrations from the gimbal assembly 192, and the secondary stage (substantially vertical stage) is configured to isolate horizontal-plane mechanical vibrations, such as yaw and fore-aft movements, from the gimbal assembly 192.

The secondary stage extends below the range of motion of the gimbal assembly 192 to function as landing gear configured to support landing of the unmanned aerial vehicle 100 on a ground surface while maintaining operation (e.g., pitch adjustments) of the gimbal assembly 192 (e.g., for perch and stare). Accordingly, the set of isolating arms 198: couple the gimbal frame—and therefore the gimbal motors and the optical sensor 190—to the backbone 110; isolate mechanical vibrations propagating through the backbone 110 from the optical sensor 190; and function as landing gear configured to support the unmanned aerial vehicle 100 in a ground position (or “resting position”). Additionally, the gimbal assembly 192 can further include a connector configured to couple to a port: arranged on a bottom side of the center section 114 of the backbone 110; and configured to route power signals and data signals from the backbone 110 to the optical sensor 190 and the gimbal motors 194 coupled to the gimbal assembly 192.

Therefore, rather than implementation of an integral gimbal assembly, the unmanned aerial vehicle 100 can include a gimbal assembly 192 configured to: transiently couple to the backbone 110 via a set of isolating arms 198 (e.g., elastomeric arms); and isolate mechanical vibrations from the backbone 110 to an optical sensor 190 coupled to the gimbal assembly 192, such as mechanical vibrations propagating through the backbone 110 and generated from operation of the set of motors 150 and the set of propellers 158.

### 7. Battery Assembly

In one implementation, the unmanned aerial vehicle 100 includes a battery assembly 160 including: a primary battery cell 161 (e.g., 4.2 volt battery, 18650 size battery); and a frame 162 coupled to the primary battery cell 161 and configured to transiently couple the battery assembly 160 to a battery receptacle of the backbone 110. In this implementation, the frame includes: a connector 165 interposed between a front end and a rear end of the battery frame and coupled to an anode end and cathode end of the primary battery cell 161; a primary magnetic element 127, defining a primary pole orientation, arranged at the front end of the battery frame and configured to magnetically couple to the primary bulkhead 131; and a hook 163 arranged at the rear end of the battery frame and configured to mechanically couple to a mechanical receiver 126 (e.g., a hook 163 slot, an engagement notch) at the secondary bulkhead 137. Alternatively, the frame can include a primary set of magnetic elements of alternating magnetic polarity.

In this implementation, the front crossbeam of the primary bulkhead 131 can include a secondary magnetic element 164, defining a secondary pole orientation opposite the primary pole orientation, configured to magnetically couple to the primary magnetic element 127 to retain the frame and therefore the primary battery cell 161 below the center section 114 of the backbone 110. For example, the mounting bracket of the primary bulkhead 131 can include a receptacle configured to receive and locate the secondary magnetic element 164 at the front crossbeam. Alternatively, the front crossbeam can include a secondary set of magnetic elements of alternating magnetic polarity configured to magnetically couple to the primary set of magnetic elements.

Additionally, the hook 163 is configured to mechanically couple to the rear crossbeam of the secondary bulkhead 137 in order to function as a fulcrum that cooperates with the primary magnetic element 127 to couple the frame of the battery assembly 160 to the airframe (i.e., the primary bulkhead 131, the secondary bulkhead 137, and the backbone 110). Furthermore, the frame: includes a positive contact pad 169 electrically coupled to a positive terminal 167 (e.g., cathode) at the top end of the primary battery cell 161; includes a negative contact pad 170 electrically coupled to a negative terminal 168 (e.g., anode) at a sidewall of the primary battery cell 161; and routes the cathode and the anode to the connector 165 of the battery frame. Thus, the primary set of magnetic elements 157 and the hook 163 of the battery frame cooperate to: locate the connector 165 at the battery connection port arranged on the bottom side of the center section 114 of the backbone 110; and maintain the battery assembly 160 mounted to the airframe during flight operation.

Additionally, the connector 165: defines a data interface configured to transmit battery state-of-charge and temperature data to the battery connection port; and further includes electrical contacts configured to supply electrical energy to battery functions, such as activating and deactivating lights arranged on the battery assembly 160.

Therefore, rather than implementing a rechargeable battery rigidly integrated into a chassis and coupled to a printed circuit board assembly, the unmanned aerial vehicle 100 can include a battery assembly 160: transiently coupled to the airframe (i.e., the primary bulkhead 131, the secondary bulkhead 137, and the backbone 110); and configured to eject, such as in response to a collision event, in order to prevent damage (e.g., fire damage) to electrical components arranged on the backbone 110.

### 7.1 Power Regulator Circuit + Dual Battery Cells

In one implementation, the backbone 110 further includes a power regulator circuit 166, such as arranged on the primary lateral section 115 and/or the secondary lateral section 116 of the backbone 110 configured to: receive an output voltage (e.g., 3.7 volts) from the primary battery cell 161; and select a set of regulation parameters (e.g., regulation topology, output voltage setpoints, switching frequency) based on the received output voltage. The power regulator circuit 166 can then, based on the regulating parameters, adjust the output voltage to: a primary voltage (e.g., 3.3 volts) for operating a primary set of components (e.g., a flight controller 180, an inertial measurement unit, a radio transceiver), in a low-voltage domain (e.g., less than five volts), arranged on the printed circuit board 111; and a secondary voltage (e.g., 6.5 volts), greater than the primary voltage, for operating a secondary set of components (e.g., a set of motor controllers), in a high-voltage domain (e.g., greater than five volts), arranged on the printed circuit board 111. The power regulator circuit 166 can then supply the primary voltage and the secondary voltage to the connector 165 to deliver electrical energy to the electrical components on the backbone 110.

In one example, the battery assembly 160 includes a single battery cell. Accordingly, the power regulator circuit 166 can: read the output voltage from the single battery cell; and select a set of regulation parameters corresponding to single-cell operation, such as by selecting a boost topology and adjusting output voltage setpoints to supply a high-voltage to electrical components, in a high-voltage domain, on the printed circuit board 111.

In another example, the battery assembly 160 includes a primary battery cell 161 and a secondary battery cell 171. Accordingly, the power regulator circuit 166 can: read a combined output voltage from the primary battery cell 161 and the secondary battery cell 171; and select a set of regulation parameters corresponding to dual-cell operation, such as by bypassing a high-voltage regulation stage to supply the combined output voltage to electrical components, in a high-voltage domain, on the printed circuit board 111 while maintaining regulation for electrical components, in a low-voltage domain, on the printed circuit board 111.

Furthermore, the unmanned aerial vehicle 100 can include a flight controller 180 arranged on the backbone 110 and configured to: access battery configuration data (e.g., battery type, cell count, operational limits) from the battery assembly 160 via a data communication line; and select operational parameters based on the battery configuration data. For example, in response to detecting a single-cell battery assembly 160 based on the battery configuration data, the flight controller 180 can: limit motor throttle range; reduce duty cycle limits; and disable non-essential subsystems during flight operations. In another example, in response to detecting a dual-cell battery assembly—including the primary battery cell 161 and the secondary battery cell 171—based on the battery configuration data, the flight controller 180 can: increase motor throttle range; increase duty cycle limits; and enable operation of high-power subsystems, such as the primary motor controller 181 and the secondary motor controller 182, to support high-speed or high-agility flight operations.

Therefore, the battery assembly 160 can include the power regulator circuit 166 to: maintain the backbone 110 electrically agnostic to input battery voltage by selecting regulation parameters at the battery assembly 160, thereby supporting plug-and-play battery swaps across different voltage configurations without requiring manual reconfiguration of electronic components on the printed circuit board 111; and prevent short circuits, overvoltage, or electrical transients from propagating to electronic components on the backbone 110 in response to sustained damage to the power regulator circuit 166 during a collision event.

### 7.1.1 Dual Battery Cells: High-Voltage Rail + Low-Voltage Rail

In one implementation, the connector 165 includes a high-voltage rail, a low-voltage rail, and a ground rail. Additionally, the primary battery cell 161 (e.g., 3.7 volts) and the secondary battery cell 171 (e.g., 3.7 volts) are electrically coupled in series to generate a combined high-voltage output (e.g., 7.4 volts). The power regulator circuit 166 can then supply this combined high-voltage output to the high-voltage rail of the connector 165. Accordingly, the primary motor controller 181 and the secondary motor controller 182 regulate delivery of electrical energy from the high-voltage rail to corresponding motors in the set of motors 150, thereby driving rotation of respective propellers 158 during a flight operation.

Additionally, the power regulator circuit 166 selectively couples the low-voltage rail of the connector 165 to an individual battery cell, such as the primary battery cell 161 or the secondary battery cell 171. More specifically, the power regulator circuit 166 implements a switching topology configured to alternate electrical coupling of the low-voltage rail between the primary battery cell 161 and the secondary battery cell 171, thereby maintaining a regulated and balanced low-voltage output at the low-voltage rail. The set of electrical traces arranged across the printed circuit board 111 route electrical energy from the low-voltage rail to low-voltage electronic components on the backbone 110 (e.g., the flight controller 180, the time-of-flight sensors 146).

For example, the power regulator circuit 166 can: initially couple the low-voltage rail to the primary battery cell 161 (e.g., at 3.7 volts), while the secondary battery cell 171 remains disconnected from the low-voltage rail; in response to detecting the voltage of the primary battery cell 161 falling below a threshold voltage (e.g., 3.6 volts), couple the low-voltage rail to the secondary battery cell 171 (e.g., still at or above 3.7 volts) to maintain a stable voltage output; and repeatedly alternate coupling between the primary battery cell 161 and the secondary battery cell 171 based on respective cell voltages, thereby stabilizing low-voltage output at the low-voltage rail.

Therefore, the unmanned aerial vehicle 100 simultaneously supplies increased voltage to the set of motors 150 to support higher rotational speeds, while selectively coupling battery cells 161 and 171 to the low-voltage rail to balance individual cell discharge and extend overall battery lifespan.

### 7.2 Variation: End Caps

In one implementation, the battery assembly 160 includes a primary battery cell 161 including: a positive terminal 167 arranged at a top end of the primary battery cell 161; and a negative terminal 168 arranged on a side of the primary battery cell 161. The battery assembly 160 can further include a primary cap arranged over the top end of the primary battery cell 161 and including: a top segment; and a sleeve segment. The top segment is coupled to the top end of the primary battery cell 161 and includes a positive contact pad 169 electrically coupled to the positive terminal 167 of the primary battery cell 161. The sleeve segment extends along the side of the primary battery cell 161, includes a negative contact pad 170 electrically coupled to the negative terminal 168 of the primary battery cell 161, includes the power regulator circuit 166, and includes the connector 165 configured to electrically couple to the battery port arranged on the center section 114 of the backbone 110. The primary cap can further include the primary magnetic element 127 configured to magnetically couple to the secondary magnetic element 164 arranged on the primary bulkhead 131.

In this implementation, the battery assembly 160 can further include a secondary cap arranged on a bottom end, opposite the top end, of the primary battery cell 161 and including the hook 163 configured to mechanically couple to the secondary bulkhead 137.

Accordingly, the primary cap cooperates with the secondary cap to: independently retain the battery assembly 160 to the airframe (i.e., the backbone 110, the primary bulkhead 131, and the secondary bulkhead 137); minimize structural mass of the battery assembly by limiting cap material to distal ends of the primary battery cell 161; and locate structural reinforcement at distal ends of the primary battery cell 161 to absorb and distribute impact loads during a collision event. Additionally, the primary cap cooperates with the secondary cap to maintain exposure of an outer wall of the primary battery cell 161, thereby maximizing thermal dissipation from the battery cell to an external environment.

Additionally, the battery assembly 160 can implement the primary cap and the secondary cap configuration described above for both a single-cell battery configuration (i.e., primary battery cell 161) and a dual-cell battery configuration (i.e., primary battery cell 161 and secondary battery cell 171).

### 8. Cover + Heat Distribution

In one implementation, the unmanned aerial vehicle 100 can include a top cover 143 extending across an outer face of the center section 114. In this implementation, the top cover 143 includes mounting features, such as through holes, that align with corresponding through holes arranged on the primary lateral section 115 and the secondary lateral section 116 of the backbone 110. Additionally, a set of fasteners can pass through these aligned through holes to couple the top cover 143 to the backbone 110 and the primary bulkhead 131.

Additionally, the top cover 143 can include: a thermally conductive lamination (e.g., a pyrolytic graphite sheet) arranged across an inner face and outer face of the top cover 143 and configured to distribute heat, generated by electrical components arranged on the outer face of the center section 114, across the top cover 143; a set of perforations 145 (e.g., vent holes) configured to route ambient airflow across the top cover 143 during a flight operation to passively dissipate heat distributed across the top cover 143 via the thermally conductive lamination.

For example, during a flight operation, the electrical components, across the outer face of the center section 114, generate heat that is distributed across the top cover 143 via the thermally conductive lamination. The set of perforations 145 then pass ambient air within an interstice between the inner face of the top cover 143 and the outer face of the center section 114 to dissipate the heat across the top cover 143.

Similarly, the unmanned aerial vehicle 100 can include a bottom cover 144 extending across an interior face 123 of the center section 114. In this implementation, the bottom cover 144 can be snap-mounted onto the interior face 123 of the center section 114 such that an inner face of the bottom cover 144 is positioned in contact or near-contact with the interior face 123 of the center section 114. Additionally, the bottom cover 144 can include: a thermally conductive lamination (e.g., a pyrolytic graphite sheet) arranged across an inner face and outer face of the bottom cover 144 and configured to distribute heat generated by the battery assembly 160, which is arranged below the bottom cover 144, across the bottom cover 144; and a set of perforations 145 (e.g., vent holes) configured to route ambient airflow across the bottom cover 144 during a flight operation to passively dissipate heat distributed across the bottom cover 144 via the thermally conductive lamination.

For example, during a flight operation, the battery assembly 160 generates heat beneath the bottom cover 144, which is distributed across the bottom cover 144 via the thermally conductive lamination. The set of perforations 145 then pass ambient airflow within an interstice between the outer face of the bottom cover 144 and the battery assembly 160 to dissipate the heat distributed across the bottom cover 144.

Therefore, the unmanned aerial vehicle 100 can include a top cover 143 that cooperates with a bottom cover 144 to: shield electrical components arranged on the backbone 110 from environmental exposure and mechanical impact during flight and handling; and distribute heat generated by internal components across thermally conductive laminations on the top and bottom covers, such that the distributed heat is passively dissipated through ambient airflow routed via the respective sets of perforations.

### 9. Disclaimer

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. An unmanned aerial vehicle comprising:
a backbone:
consisting essentially of a printed circuit board comprising:
a center section;
a first lateral section;
a second lateral section;
a first flex section coupling the center section to the first lateral section; and
a second flex section coupling the center section to the second lateral section opposite the first lateral section; and
foldable along the first flex section and the second flex section;
a set of bulkheads:
coupled to the first lateral section and the second lateral section of the backbone; and
rigidly retaining the center section, the first lateral section, and the second lateral section of the backbone in a convex geometry;
a set of booms coupled to the set of bulkheads and extending outwardly from the backbone;
a set of motors, each motor in the set of motors:
arranged on a distal end of a boom in the set of booms; and
configured to rotate a rotor to generate lift; and
a battery assembly configured to transiently couple to the backbone.

2. The unmanned aerial vehicle of claim 1, wherein the printed circuit board consists of:
a flexible circuit board layer; and
a rigid circuit board layer:
bonded to the flexible circuit board layer;
relieved over the first flex section between the center section and the first lateral section of the backbone; and
relieved over the second flex section between the center section and the second lateral section of the backbone.

3. The method of claim 2:
wherein the center section of the backbone is formed by the rigid circuit board layer and comprises a center set of electrical traces;
wherein the first lateral section of the backbone is formed by the rigid circuit board layer and comprises a first set of electrical traces;
wherein the second lateral section of the backbone is formed by the rigid circuit board layer and comprises a second set of electrical traces;
further comprising:
a flight controller arranged on the center section and electrically coupled to the center set of electrical traces;
a first motor controller:
arranged on the first lateral section;
electrically coupled to the first set of electrical traces; and
electrically coupled to a first motor in the set of motors; and
a second motor controller:
arranged on the second lateral section;
electrically coupled to the second set of electrical traces; and
electrically coupled to a second motor in the set of motors; and
wherein the flexible circuit board layer comprises a third set of electrical traces that electrically couple the center set of electrical traces to:
the first set of electrical traces across the first lateral section; and
the second set of electrical traces across the second lateral section.

4. The unmanned aerial vehicle of claim 3:
wherein the flight controller, the first motor controller, and the second motor controller are arranged on an interior face of the backbone;
further comprising a cover:
extending across the interior face of the backbone; and
comprising a set of perforations; and
wherein the center section further comprises an aperture that direct airflow across the interior face of the backbone and outward through the set of perforations to passively cool the flight controller, the first motor controller, and the second motor controller.

5. The unmanned aerial vehicle of claim 1:
further comprising a set of fasteners;
wherein the first lateral section and the second lateral section of the backbone comprises a set of bores;
wherein, in a flat pack configuration:
the set of bulkheads are separated from the backbone; and
the first lateral section and the second lateral section of the backbone are coplanar with the center section of the backbone; and
wherein, in a deployed configuration:
the first lateral section is folded about the first flex section to locate the first lateral section orthogonal to the center section;
the second lateral section is folded about the second flex section to locate the second lateral section orthogonal to the center section and facing the first lateral section; and
the set of bulkheads are coupled to the backbone by passing the set of fasteners through the set of bores and into the set of bulkheads.

6. The unmanned aerial vehicle of claim 1:
further comprising:
a mechanical receiver arranged on a first bulkhead in the set of bulkheads; and
a first magnetic element arranged on a second bulkhead in the set of bulkheads; and
wherein the battery assembly comprises:
a first battery cell; and
a frame coupled to the first battery cell and comprising:
a hook:
arranged on a first end of the first battery cell; and
configured to mechanically couple to the mechanical receiver; and
a second magnetic element:
arranged on a second end, opposite the first end of the first battery cell;
configured to magnetically couple to the first magnetic element to transiently retain the battery assembly to the backbone; and
configured to magnetically decouple from the first magnetic element to release the battery assembly from the backbone responsive to a collision event.

7. The unmanned aerial vehicle of claim 6, wherein the frame further comprises:
a connector configured to couple to a port arranged on the center section of the backbone; and
a power regulator circuit configured to:
receive an output voltage from the first battery cell;
adjust the output voltage to:
a first voltage for operating a first set of components, in a low-voltage domain, arranged on the printed circuit board; and
a second voltage, greater than the first voltage, for operating a second set of components, in a high-voltage domain, arranged on the printed circuit board; and
supply the first voltage and the second voltage to the connector.

8. The unmanned aerial vehicle of claim 6:
wherein the first battery cell comprises:
a positive terminal arranged at an end of the first battery cell; and
a negative terminal arranged on a side of the first battery cell; and
wherein the frame further comprises:
a positive contact pad electrically coupled to the positive terminal of the first battery cell; and
a negative contact pad electrically coupled to the negative terminal of the first battery cell.

9. The unmanned aerial vehicle of claim 1:
wherein a first motor, in the set of motors, comprises:
a stator mount comprising:
a column; and
a boom cup extending laterally from a base of the column and configured to receive a distal end of a first boom in the set of booms;
a radial array of stator windings arranged about the column above the boom cup;
a rotor comprising:
a cylindrical aperture configured to receive the column; and
a set of magnetic elements arranged within the cylindrical aperture and facing the radial array of stator windings; and
a propeller coupled to the rotor; and
wherein the radial array of stator windings is configured to inductively couple to the set of magnetic elements to
retain the rotor in a vertical position over the column of the stator mount; and
induce rotation of the rotor and the propeller to generate lift.

10. The unmanned aerial vehicle of claim 9, wherein the rotor and the propeller comprise a unitary structure configured to separate from the stator mount responsive to a collision event.

11. The unmanned aerial vehicle of claim 9, wherein the boom cup:
defines an upward-facing aperture;
is oversized for the distal end of the first boom in the set of booms; and
is adhesively bonded to the distal end of the first boom.

12. The unmanned aerial vehicle of claim 1, wherein the set of bulkheads comprise a first bulkhead comprising:
a first crossbeam:
arranged proximal a front end of the backbone; and
interposed between the first lateral section and the second lateral section of the backbone; and
a first mounting bracket:
coupled to the first crossbeam;
interposed between the first lateral section and the second lateral section of the backbone;
comprising a first set of bosses:
aligned with a first set of bores on the first lateral section and the second lateral section of the backbone; and
configured to receive a first set of fasteners to rigidly retain the first mounting bracket to the backbone; and
cooperating with the first crossbeam to rigidly retain the center section, the first lateral section, and the second lateral section of the backbone in the convex geometry.

13. The unmanned aerial vehicle of claim 12, wherein the set of bulkheads further comprise a second bulkhead comprising:
a second crossbeam:
arranged proximal a rear end of the backbone; and
interposed between the first lateral section and the second lateral section of the backbone; and
a second mounting bracket:
coupled to the second cross beam; and
comprising a second set of bosses:
aligned with a second set of bores arranged on the center section of the backbone; and
configured to receive a second set of fasteners to rigidly retain the second mounting bracket to the backbone;
cooperating with the first bulkhead to rigidly retain the center section, the first lateral section, and the second lateral section of the backbone in the convex geometry.

14. The unmanned aerial vehicle of claim 1, wherein a first bulkhead, in the set of bulkheads, comprises a first boom mount comprising:
a pivot configured to pass through a proximal end of a first boom in the set of booms;
a first demilune cup:
defining a first internal radius approximating an outer radius of the proximal end of the first boom;
extending along a first axis orthogonal to the center section of the backbone; and
configured to, in a flight configuration:
elastically deform about the proximal end of the first boom;
seat the proximal end of the first boom within the first demilune cup; and
return to a first nominal geometry to retain the first boom along the first axis orthogonal to the center section of the backbone; and
a second demilune cup:
defining a second internal radius approximating the outer radius of the proximal end of the first boom;
extending along a second axis parallel to the center section of the backbone;
and
configured to, in a stow configuration:
elastically deform about the proximal end of the first boom;
set the proximal end of the first boom within the second demilune cup; and
return to a second nominal geometry to retain the first boom along the second axis parallel to the center section of the backbone.

15. The unmanned aerial vehicle of claim 1, further comprising:
an optical sensor; and
a gimbal assembly comprising:
a motorized gimbal:
supporting the optical sensor; and
configured to drive the optical sensor over a range of positions;
a set of legs extending laterally from the motorized gimbal; and
a set of isolating arms:
formed of an elastomeric material;
coupling the set of legs to retention features arranged on the first lateral section and the second lateral section of the backbone; and
configured to isolate the motorized gimbal from mechanical vibrations propagating through the set of booms into the backbone.

16. An unmanned aerial vehicle comprising:
a chassis comprising:
a backbone:
consisting essentially of a printed circuit board comprising:
a center section;
a first lateral section;
a second lateral section;
a first flex section coupling the center section to the first lateral section; and
a second flex section coupling the center section to the second lateral section opposite the first lateral section; and
foldable along the first flex section and the second flex section; and
a set of bulkheads:
coupled to the first lateral section and the second lateral section of the backbone; and
rigidly retaining the center section, the first lateral section, and the second lateral section of the backbone in a convex geometry;
a set of booms pivotably coupled to the chassis;
a set of motors, each motor in the set of motors:
arranged on a distal end of a boom in the set of booms; and
configured to rotate a rotor to generate lift; and
a battery assembly configured to transiently couple to the backbone.

17. The unmanned aerial vehicle of claim 16, wherein the backbone consists of:
a flexible circuit board layer; and
a rigid circuit board layer
bonded to the flexible circuit board layer
relieved over the first flex section between the center section and the first lateral section; and
relieved over the second flex section between the center section and the second lateral section.

18. The unmanned aerial vehicle of claim 16:
further comprising a set of fasteners;
wherein the first lateral section and the second lateral section of the backbone comprises a set of bores;
wherein, in a flat pack configuration:
the set of bulkheads are separated form the backbone; and
the first lateral section and the second lateral section of the backbone are coplanar with the center section of the backbone; and
wherein, in a deployed configuration:
the first lateral section is folded about the first flex section to locate the first lateral section orthogonal to the center section;
the second lateral section is folded about the second flex section to locate the second lateral section orthogonal to the center section and facing the first lateral section; and
the set of bulkheads are coupled to the backbone by passing the set of fasteners through the set of bores and into the set of bulkheads.

19. The unmanned aerial vehicle of claim 16:
wherein a first motor, in the set of motors, comprises:
a stator mount comprising:
a column; and
a boom cup extending laterally from a base of the column and configured to receive a distal end of a first boom in the set of booms;
a radial array of stator windings arranged about the column above the boom cup;
a rotor comprising:
a cylindrical aperture configured to receive the column; and
a set of magnetic elements arranged within the cylindrical aperture and facing the radial array of stator windings; and
a propeller coupled to the rotor; and
wherein the radial array of stator windings is configured to inductively couple to the set of magnetic elements to:
retain the rotor in a vertical position over the column of the stator mount; and
induce rotation of the rotor and the propeller to generate lift.

20. An unmanned aerial vehicle:
comprising:
a backbone:
comprising a printed circuit board comprising:
a center section;
a first lateral section;
a second lateral section;
a first flex section coupling the center section to the first lateral section; and
a second flex section coupling the center section to the second lateral section opposite the first lateral section; and
foldable along the first flex section and the second flex section;
a bulkhead:
coupled to the first lateral section and the second lateral section of the backbone; and
rigidly retaining the center section, the first lateral section, and the second lateral section of the backbone in a convex geometry;
a set of booms pivotably coupled to the bulkhead;
a set of motors, each motor in the set of motors, arranged on a distal end of a boom in the set of booms;
a battery assembly configured to transiently couple to the backbone; and
wherein, in a flat pack configuration
the bulkhead is separated from the backbone; and
the first lateral section and the second lateral section of the backbone are coplanar with the center section of the backbone; and
wherein, in a deployed configuration:
the first lateral section and the second lateral section are orthogonal to the center section of the backbone; and
the bulkhead is coupled to the backbone by passing a set of fasteners through a set of bores of the backbone and into the bulkhead.
